(19) United States
(12) Patent Application Publication
(10) Pub. No.: US 2007/0005419 A1
(43) Pub. Date: Jan. 4, 2007

(54) Recommending location and services via geospatial collaborative filtering

(75) Inventors: Eric J. Horvitz, Kirkland, WA (US); John C. Krumm, Redmond, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/171,940

(22) Filed: Jun. 30, 2005

(51) Int. Cl. G06Q 30/00

(52) U.S. Cl. 705/14

(57) ABSTRACT

Geospatial collaborative filtering (CF) with spatial (or location) logs and location updates that facilitates recommending location and/or services information to an active user. A location tracking system tracks the user, and is employed in part to determine when the user is associated with the location, if the user pauses at the location and how long the user dwells at the location. Based in part on this data, collaborative filtering of data from others who have visited the location is applied to provide suggestions to the active user. Additionally, new information related to the location, nearby locations, and services can be presented to the user. The information can be related to businesses, weather conditions, what previous users have selected when at that location, and any amount of data desired to be accessed, for example.

### BACKGROUND

The Internet continues to make available ever-increasing amounts of information which can be stored in databases and accessed therefrom. Additionally, with the proliferation of portable terminals (e.g., notebook computers, cellular telephones, PDAs, and other similar communications devices), users are becoming more mobile, and hence, trackable with respect to buying habits and locations that they tend to frequent. For example, many devices are being designed with a geographic location tracking technology such as Global Positioning System (GPS) for reasons of safety, finding travel destinations, etc. Thus, according to GPS and other location determination technologies, it now becomes possible to determine the location of the user.

For example, knowledge of where the user has traveled, currently is, and is heading in an urban canyon, which includes structures such as multi-story buildings (principally, and whether the user is inside or outside of the building), but also include trees, hills, and tunnels (generally), can be of value to the user and to companies that seek to benefit economically by knowledge of the user location by providing location-based services to the user.

Companies have long recognized the value in knowing information about their customers and those they target as new customers. Thus, user information is requested for most any kind of online website access, credit registration, purchases (free or otherwise), etc. However, there remains a disconnect in the way these vast amounts of information can be usefully employed for the benefit of both the user and the corporation.

The growth of Internet commerce has stimulated the use of collaborative filtering (CF) algorithms as recommender systems. Such systems leverage knowledge about the known preferences of multiple users to recommend items of interest to other users. CF methods have been harnessed to make recommendations about such items as web pages, movies, books, and toys. Researchers have proposed and evaluated many approaches for generating recommendations. Memory-based and model-based algorithms have been analyzed. See, Breese, J.; Heckerman, D.; and C. Kadie, “Empirical Analysis of Predictive Algorithms for Collaborative Filtering,” Uncertainty in Artificial Intelligence. Proceedings of the Fourteenth Conference (1998), Morgan Kaufman, 1998, pp. 43-52. Researchers have explored a number of variants of algorithms for collaborative filtering, including combinations of methods that integrate memory-based and model-based approaches. See, for example, D. M. Pennock and E. Horvitz. Collaborative Filtering by Personality Diagnosis: A Hybrid Memory- and Model-Based Approach, IJCAI Workshop on Machine Learning for Information Filtering, International Joint Conference on Artificial Intelligence (IJCAI-99), August 1999, Stockholm, Sweden.

The goal of CF is to predict the preferences of one user, referred to as the active user, based on the preferences of a group of users. For example, given the active user's ratings for several movies and a database of other users' ratings, the system predicts how the active user would rate unseen movies. The key idea is that the active user will prefer those items that like-minded people prefer, or even that dissimilar people do not prefer.

The effectiveness of any CF algorithm is ultimately predicated on the underlying assumption that human preferences can be clustered and correlated—if they were not, then informed prediction would not be possible. There does not seem to be a single, obvious way to predict preferences, nor to evaluate effectiveness, and many different algorithms and evaluation criteria have been proposed and tested.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The disclosed innovation combines collaborative filtering (CF) with spatial (or location) logs and location updates that facilitate recommending location and/or services information to an active user that comes to a location. A location tracking system tracks the user, and is employed to determine at least when the user is associated with the location, velocity of the user, if the user pauses at the location and how long the user dwells at the location. Based in part on this data, information is presented to the user when associated with the location. This can include while the user approaches the location, interacts at the location, and is leaving the location. Additionally, new information related to the location, nearby locations, and services can be presented to the user. The information can be related to businesses, weather conditions, what previous users have selected when at that location, and any amount of data desired to be accessed, for example. In support thereof, a database is provided that stores and updates large amounts of data associated with a large number of users.

Accordingly, there is provided a system that facilitates the recommendation of location data and services. The system includes a tracking component that tracks a location of a user, a sensing component that senses interaction data of the user at the location, and a data component that processes the interaction data and suggests new data to the user while associated with the location. The data component includes a database that can be mined for all or portions of a wide variety of data. A filtering component facilitates collaborative filtering on a datastores of data to provide recommendations to the active user.

In another aspect, one or more models of locations and services that a user is likely to already know about are used so as to weight more highly recommendations about locations and services that a user would find informative versus redundant with his or her prior knowledge. In one approach to integrating a model of user's knowledge about recommendations, popularity filtering can be employed, where the overall popularity of an item is utilized as an indication of the probability that a user already knows about an item and diminish the score given to that item in deriving suggestions for the user.

In yet another aspect thereof, a learning and reasoning component is provided that employs a probabilistic and/or statistical-based analysis to prognose or infer an action that a user desires to be automatically performed.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a collaboration system according to an innovative aspect.

FIG. 2 illustrates a methodology of developing a collaborative database and recommending information based on collaborative filtering.

FIG. 3 illustrates a collaboration system that employs a learning and reasoning component, which facilitates automating one or more features.

FIG. 4 illustrates a methodology of developing inference data based upon user stops and user interactions therewith.

FIG. 5 illustrates a methodology of recommending suggestions based on popularity filtering.

FIG. 6 illustrates a methodology of employing clustering as a means for enhancing collaborative filtering.

FIG. 7 illustrates a methodology of collaborative filtering that is based in part on a profile and/or preferences of the active user.

FIG. 8 illustrates a methodology of employing a learning and reasoning system to manage data storage for collaborative filtering.

FIG. 9 illustrates a methodology of time filtering as an aspect of collaborative filtering.

FIG. 10 illustrates a methodology of directing advertising and/or other enticements to the active user as part of the collaborative filtering process.

FIG. 11 illustrates a methodology of abstraction processing for locations according to a disclosed aspect.

FIG. 12 illustrates a methodology of applying learning and reasoning to an abstraction generation process.

FIG. 13 illustrates a diagram of a system that coordinates collaborative filtering on a small scale to a large scale.

FIG. 14 illustrates a diagram that shows a system that recommends location and/or services in accordance with the invention.

FIG. 15 illustrates a methodology of presenting location and services based on inference information in combination with collaborative filtering and pause/velocity data.

FIG. 16 illustrates an exemplary database that can be employed to provide location and services recommendation in accordance with the invention.

FIG. 17 illustrates a block diagram of a computer operable to execute collaborative filtering the disclosed architecture.

FIG. 18 illustrates a schematic block diagram of an exemplary computing environment in which collaborative filtering can be implemented.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

As used herein, terms “to infer” and “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

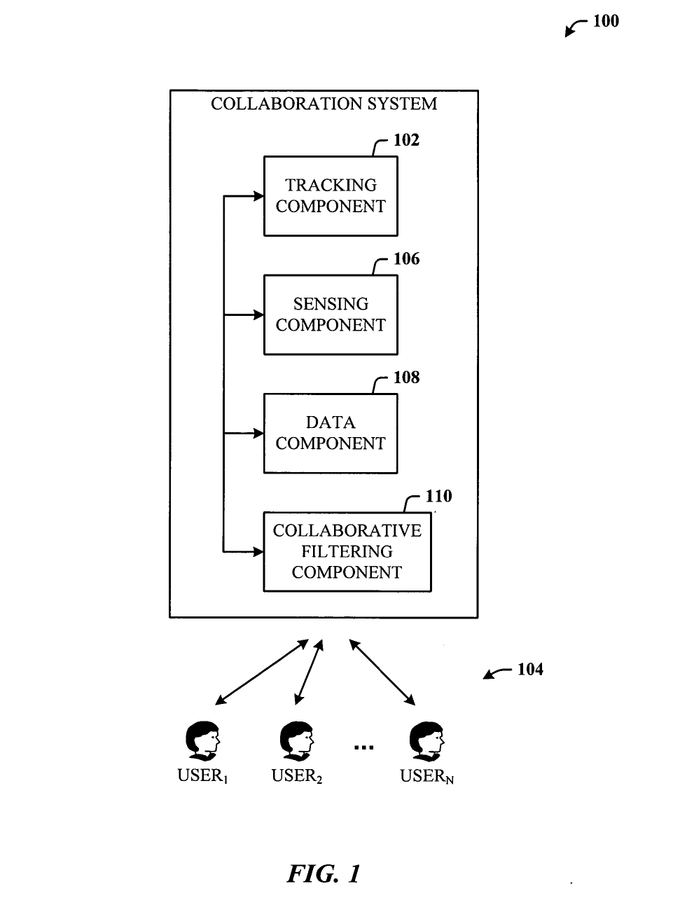

Referring initially to the drawings, FIG. 1 illustrates a geospatial collaborative filtering system 100 according to an innovative aspect. The disclosed innovation combines collaborative filtering (CF) with spatial (or location) logs and location updates to facilitate recommending location and/or services information to a user that comes to a location. The system 100 includes a tracking component 102 that tracks one or more users 104 (denoted USER₁, USER₂, . . . , USER_{N}) via user devices (not shown) that potentially could interact with the system 100. A sensing component 106 of the system 100 interfaces to the tracking component 102 to process at least one of tracking information therefrom and user interaction information generated in response to user interaction at a location. The sensing component 106 can include one or more sensors and/or devices that work separately and/or cooperatively with each other and separately or in combination with the tracking component 102 to determine the identity of each of the users 104 or uniquely tag the users 104 such that a data component 108 of the system 100 can process, store, and retrieve data associated with each of the users 104 as needed. The system 100 also includes a filtering component 110 that facilitates collaborative filtering of data of the data component 108 to make recommendations to the one or more user 104. Thus, the system 100 manages a large amount of data that can be collaboratively filtered based on spatial parameters, and exposed to one or more users based on proximity to a location.

In one implementation and operation thereof, a user approaches a location (e.g., a cross street) that is identifiable using a geographic location technology (e.g., GPS-Global Positioning System). Coordinates associated with that location can then be used to retrieve information from the data component 108 related to at least that location (e.g., buildings, businesses, structures, other users, . . . ), and additional information related to the user and/or user preferences. For example, if the user simply approaches the location, as he or she has done in the past, that information can be stored in association with the user identity information indicating that the user, with some calculable frequency, returns to that location.

From the location coordinate information, other parameters can be determined. For example by taking at least two location readings in a short period of time, speed and direction can be determined. By taking and averaging multiple readings over time, more accurate information can be obtained about the travels of the user. Additionally, if the location information does not change over a period of time, the user's “dwell time” can be processed and stored as a further indication of interest by the user in staying at that location. Thus, given location information, speed, heading, and dwell of a user at a given location, various types and amounts of information can be processed, and where suitable, presented to the user.

For example, if other users frequent that location, information can be presented to the first user that not only provides information that the first user desires, but information that the other users typically want to see at that location, or related to that location. If the other users typically walk to a nearby attraction from this location, this attraction data can be presented to the first user as an option that is typically exercised by others who also frequented this location.

From the foregoing, it is to be appreciated that given the capability of determining such information about where the user is going, how long the user dwells at a location, how the user reacts to information presented at that location, whether based on user preferences, historical data and/or data of other users, for example, benefits can be obtained both for personal, as well as commercial uses. Storing this data, and then collaboratively filtering the data of other users to make recommendations for an active user provides significant improvements for location and location-based services. This will be described in more detail infra.

The disclosed innovation builds a database of places that people stop, based on, for example, watching location tracking signals (e.g., GPS or other signals) show a velocity going to zero for an extended period of time or to a slow velocity when GPS signals are lost (e.g., entering “parking garage scenario”), and based on logs of where people stop and do things. Additionally, the logs can include where a particular user (the “primary subject” of the inferences) stops. Clustering can now be performed, and more specifically, collaborative filtering is applied to make recommendations about places to stop. Such locations can be placed in an overall list that is available to users in a “I am planning my day setting,” or in a real-time advisory system that recommends locations as a user is approaching locations that are inferred to have a high probability of being desirable based on the analysis of the population of users.

It is well known in the field that collaborative filtering algorithms can be applied to items purchased. In one application, book sellers include collaborative filtering by offering additional selections that others have made based on a first selection of the active user. For example, “You may also be interested in “The Sun Also Rises by Ernest Hemingway.” Applying this methodology to location and/or services, an exemplary recommendation can be the following, “Given the places you have tended to stop and an analysis of where people go that tend to go to places that you go to, you may be interested in stopping at the Pacific Science Center”, etc. This is because this location has not been observed before in the active user's logs. To prepare for this, logs of many users are collected and processed. The logs are “anonymized” to remove personally identifiable information such as home address, etc. Demographic information can be stored so as to also consider that in making the recommendations (e.g., gender, salary, job type, type of car, . . . ). Other accessible information can include retail locations, public parks, natural landmarks, museums, etc.

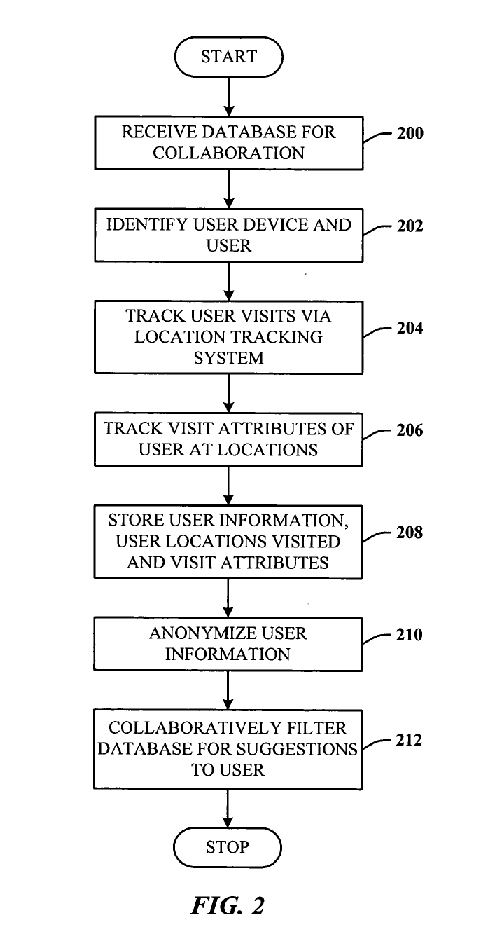

FIG. 2 illustrates a methodology of developing a collaborative database and recommending information based on collaborative filtering in accordance with the invention. While, for purposes of simplicity of explanation, the one or more methodologies shown herein, e.g., in the form of a flow chart or flow diagram, are shown and described as a series of acts, it is to be understood and appreciated that the subject innovation is not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

At 200, a database is received for storing data. At 202, a user is identified by a user device. At 204, as the user makes stops or visits at various locations, this location information is logged. By utilizing a location tracking system (e.g., GPS), it is possible to track the location of the user. Thus, speed and direction can be computed, for example. At 206, user interaction is also tracked at each location in the form of visit or stop attributes. For example, if the user stops at a location for about twenty minutes, this is logged as a stop attribute for that location and user. At 208, for the duration of the user tacking process, all visit attributes are logged and stored in the database. At 210, the stored user information is anonymized into the general database to remove personally identifiable information from being returned during collaborative filtering.

At 212, as the user location and attributes are tracked and logged, the system performs collaborative filtering on the data of other user information stored therein to generate suggestions to the active user related to, for example, locations that others have visited, traffic patterns nearby, weather conditions, and so on. In addition to the presentation of a first set of information, additional information can be presented related to what other users have requested and/or perceived when at that location. Recommendations can be via a portable terminal device, such as a cellular telephone or a PDA, for example.

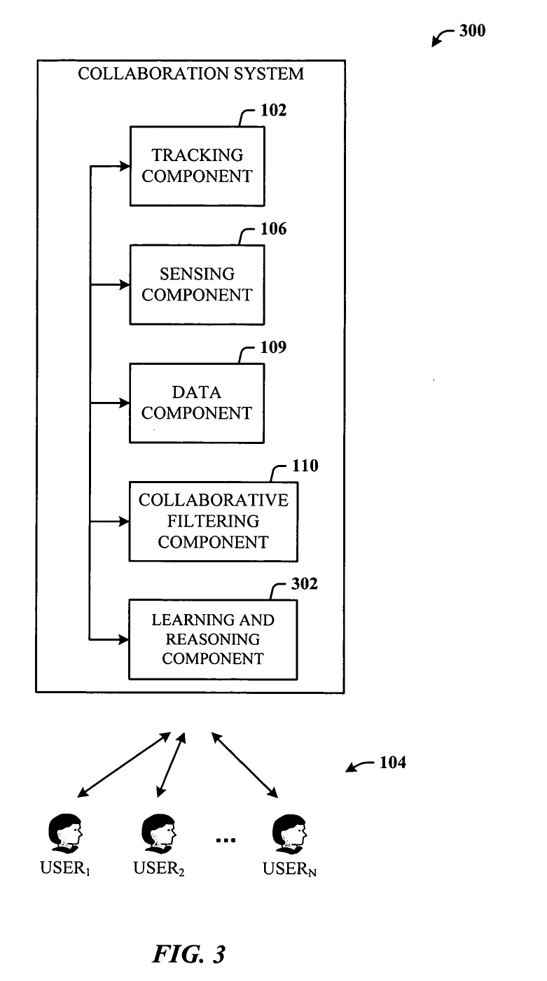

FIG. 3 illustrates a collaboration system 300 that employs a learning and reasoning (LR) component 302, which facilitates automating one or more features. The learning and reasoning component 302 can interface to each of the tracking component 102 to process tracking data, the sensing component 106 to monitor user interaction data of the one or more users 104, the data component 108 to interact with and/or impact the type of information to present and/or suggest, and the collaborative filtering component 110 to facilitate enhanced clustering and inference generations.

The subject invention (e.g., in connection with selection) can employ various LR-based schemes for carrying out various aspects thereof. For example, a process for determining what information to suggest to the user at the location can be facilitated via an automatic classifier system and process. Moreover, where the database of collaboration data is distributed over several network locations, the classifier can be employed to determine which database location will be selected for processing the user information.

A classifier is a function that maps an input attribute vector, x=(x1, x2, x3, x4, xn), to a class label class(x). The classifier can also output a confidence that the input belongs to a class, that is, f(x)=confidence(class(x)). Such classification can employ a probabilistic and/or statistical-based analysis (e.g., factoring into the analysis utilities and costs) to prognose or infer an action that a user desires to be automatically performed. In the case of database systems, for example, attributes can be words or phrases or other data-specific attributes derived from the words (e.g., database tables, the presence of key terms), and the classes are categories or areas of interest (e.g., levels of priorities for types of information to be presented).

A support vector machine (SVM) is an example of a classifier that can be employed. The SVM operates by finding a hypersurface in the space of possible inputs that splits the triggering input events from the non-triggering events in an optimal way. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated from the subject specification, the subject invention can employ classifiers that are explicitly trained (e.g., via a generic training data) as well as implicitly trained (e.g., via observing user behavior, receiving extrinsic information). For example, SVM's are configured via a learning or training phase within a classifier constructor and feature selection module. Thus, the classifier(s) can be used to automatically learn and perform a number of functions, including but not limited to, determining according to a predetermined criteria (e.g., user preferences data) what data to present, when to present the data, what the suggested new data should be, how data should be clustered, the extent of clustering, and inferences that can be made and suggested to the active user based on temporal considerations, and so on.

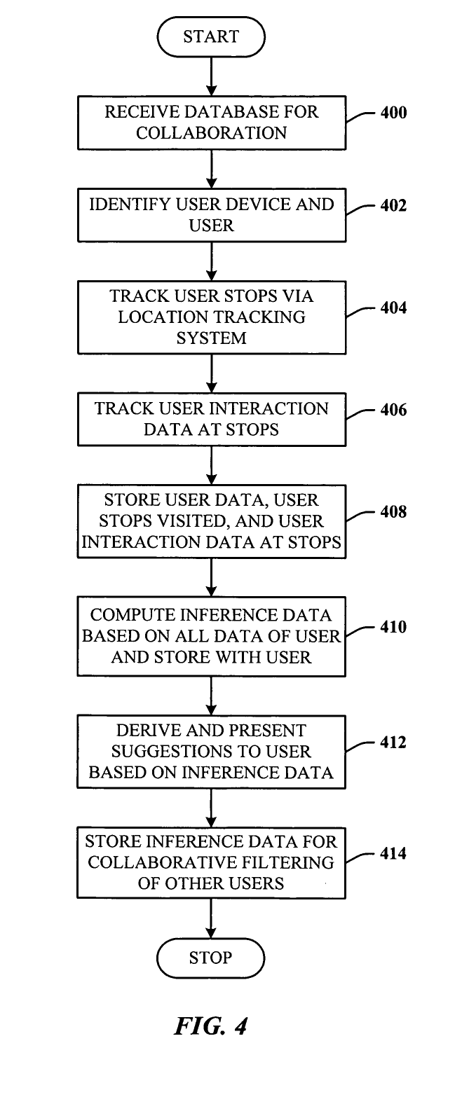

FIG. 4 illustrates a methodology of developing inference data based upon user stops and user interactions therewith. At 400, a database is received for collaboration purposes. At 402, an active user is identified via an associated user device. At 404, the location tracking system tracks user data, for example, movement, direction, and velocity. At 406, user interactions at each stop can also be tracked. For example, does the user make a purchase, at what altitude does the user ascend or descend (e.g., based on barometric pressure data), weather conditions during these events, and at what locations these events occur. At 408, all or parts of this information can be stored. At 410, inferences can be generated based on the stored data, and/or as the data accumulates in realtime. At 412, suggestions to the active user can be created based on the actual data and/or the inference data. In either case, the inference data can then be stored and utilized for collaborative filtering for other users, as indicated at 414.

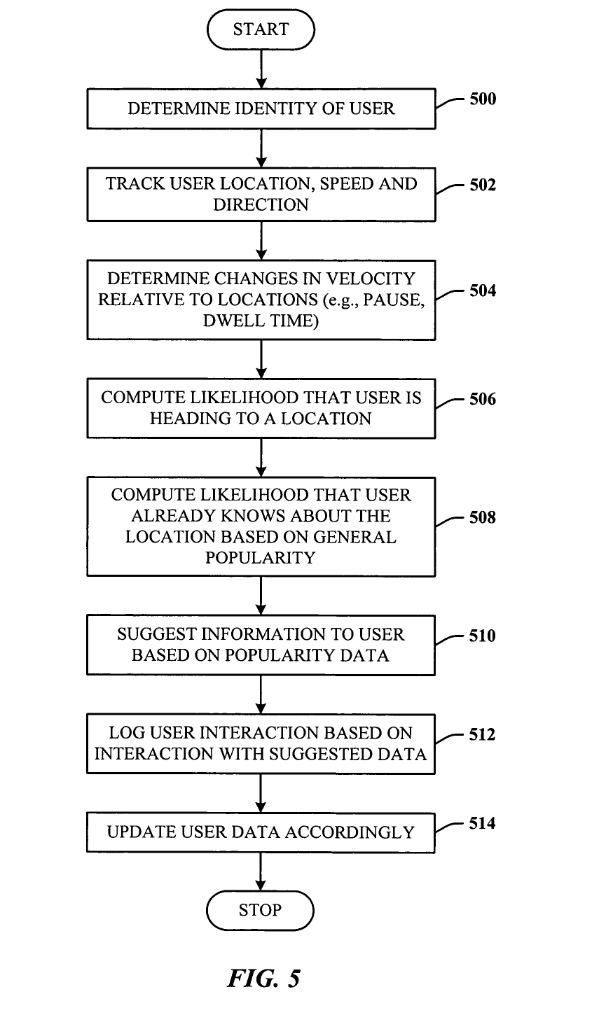

FIG. 5 illustrates a methodology of recommending suggestions based on popularity filtering. See Breese et al., referenced supra. The likelihood that a user already knows about a location based on the popularity of the location can be computed so as to ensure informativeness. For example, even if a user has not been tracked going to the Pacific Science Center, it is a well known location for a resident of Seattle. Popularity filtering weighs more highly recommendations for less known items (in this case, locations), using as a surrogate for “likely known by user” the popularity and salience of a location. Of course, it would be different if the system determined that a user was from out of town and did not know of the popular local attraction. However, filtering can even be applied on a national basis (e.g., the likelihood that travelers in the United States will have knowledge of Las Vegas) or even an international basis (e.g., the likelihood that travelers of the world will have knowledge of The Great Wall of China).

At 500, the user identity is determined. At 502, user movement, speed, and direction are tracked. At 504, changes in velocity relative to locations is tracked (e.g., pause or dwell times). At 506, based in part on the changes, and other information, a likelihood that the active user is heading to a location, can be computed. At 508, the likelihood that the user already knows about the location based on general popularity, is computed. At 510, the system suggests information to the active user based on the popularity data. At 512, user interaction to the suggestion(s) is logged and factored in for subsequent recommendations. At 514, the database is updated accordingly. In one implementation, the user can provide as a part of his or her user profile, information about travel routines or goals (e.g., in a user's GPS-centric routing system), for example, that are typically repeated with respect to location and/or services. Knowledge of this routine information can facilitate providing suggestions or other information at a time when it is estimated that the user is about to perform or is performing this routine. For example, suggestions can be derived and presented that are opportunistic recommendations for the benefit of the user and/or an advertiser, but that identify locations and/or services that would interest the user. Such suggestions and/or associated enticements can be limited to within some distance of the route, or that could be reached as a diversion with some minimal distance on disruption to the route in progress. Moreover, the importance of this information to the user can be weighted such that if it is important to the user (e.g., a sale is occurring on a favorite item or service), then the amount of diversion can be greater from the route, of example.

Additionally, with respect to collaborative filtering, if it is determined that other users typically frequent these sales or special events, the suggestion can be of a greater urgency, or transmitted at a predetermined time before the event occurs, and according to many other criteria that the user may choose to employ in cooperation with collaborative filtering.

In a more objective example, if the system learns and reasons from data that is being logged by a large number of users that such events and/or services associated with a location are proving to be in high demand, even though the user has not in the past shown any interest, the suggestion can be presented as an enticement to the user to now reconsider due to the high interest of others who travel the route or approach similar locations. Again, suggestions can be presented based on the user location relative to the route taken and proximity to other known locations and services.

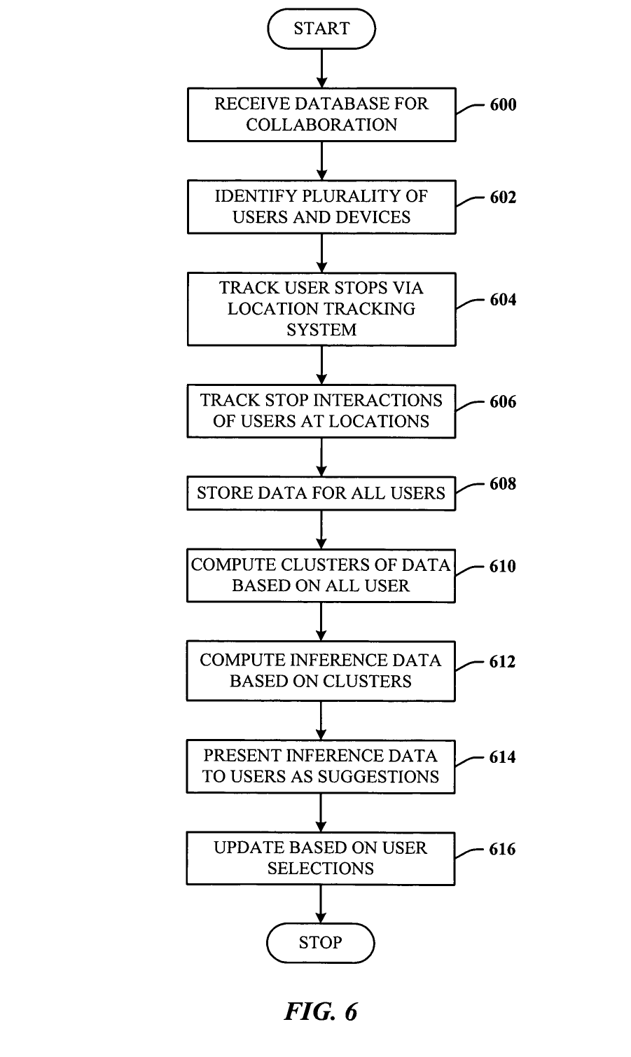

FIG. 6 illustrates a methodology of employing clustering as a means for enhancing collaborative filtering. At 600, the database is received for storing user information, and other information related to location and services, for example. At 602, users can be identified or assumed to be identified via a device or devices that they carry (e.g., a cell phone, portable computer, . . . ). Alternatively, or in combination therewith, sensing devices can be located at strategic points such that user tracking is not by a personal device carried by the user, but by external systems, or the combination of the personal device and the external sensing systems. At 604, as users move about in a certain locale or region, the system tracks their movement. This can also include the velocity and dwell time at the stops. At 606, this can also include interactions at various stops, such as making purchases, interacting with other tracked users, eating, browsing, time of day, month and year, etc., for example. At 608, this data is stored for all users.

At 610, data clustering can be employed to support making recommendations to active users. The collaborative filtering architecture of the disclosed innovation can include probabilistic graphical models, and clustering models such as K-nearest neighbors, K-means, and other statistical methods, such as Gibbs sampling. At 612, based on how the clustering is employed of each user, one or more inferred suggestions can be made based on the clustered data. At 614, the inferred suggestion is presented to the user (or user(s)). At 616, user response to the suggestion(s) is monitored, and stored.

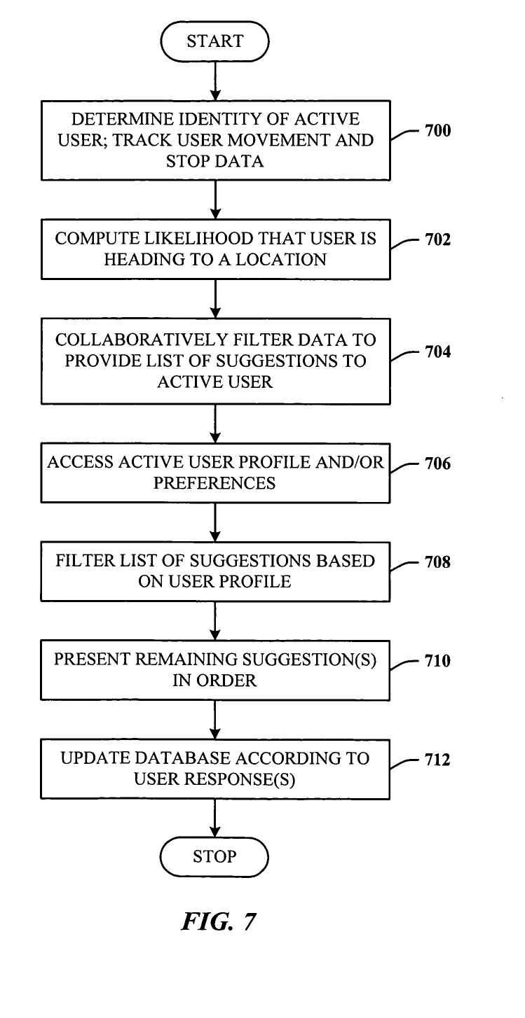

FIG. 7 illustrates a methodology of collaborative filtering that is based in part on a user profile and/or preferences of the active user. At 700, the user identify is determined, as well as user movement tracked and the associated stop data. At 702, the likelihood is computed that the user is heading to a certain location. At 704, the stored data is collaboratively filtered to provide a list of suggestions to the active user. At 706, the active user profile and/or preferences are accessed. At 708, the list of suggestions is further filtered based on the profile and/or preferences information. At 710, the remaining suggestions that passed the filter are presented to the active user. At 712, the database is updated according or the user response(s).

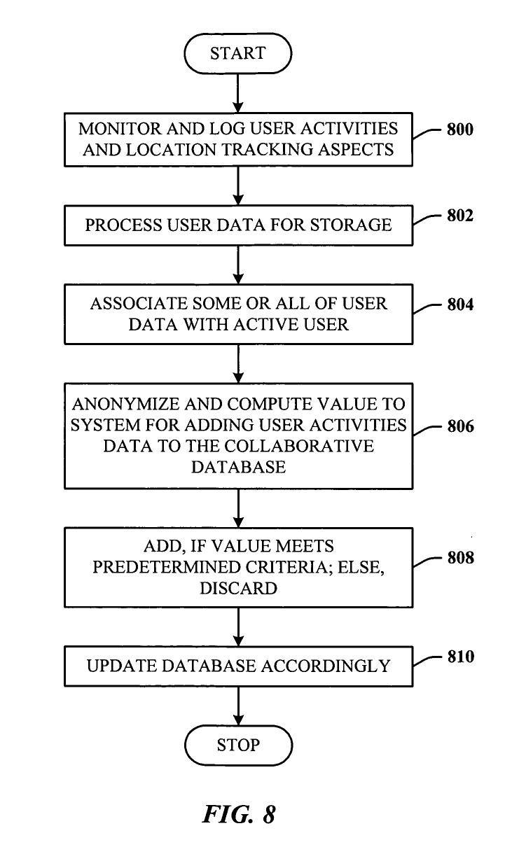

FIG. 8 illustrates a methodology of employing a learning and reasoning system to manage data storage for collaborative filtering. In one implementation, not all data is stored for all users. Given that the storage requirements can be quite demanding, the system can reason about which data should be stored and what data, if stored, would provide only in incremental contribution to the overall decisionmaking process for making suggestions. At 800, the system monitors and logs user activities and location tracking aspects. At 802, the system processes the active user data for storage. At 804, the system associates some or all of the user data with the active user. This can be more personalized information that may or may not be utilized in the collaborative filtering process. At 806, the user information is then anonymized, and a value computed for also including it in the larger pool of data for collaborative filtering. It is to be appreciated that if the user information is not considered that important or significant to the overall pool of information, there would be no need to store it. Accordingly, at 808, the data is stored, if the value meets predetermined criteria for storing; otherwise, the data is discarded. At 810, the database is updated accordingly.

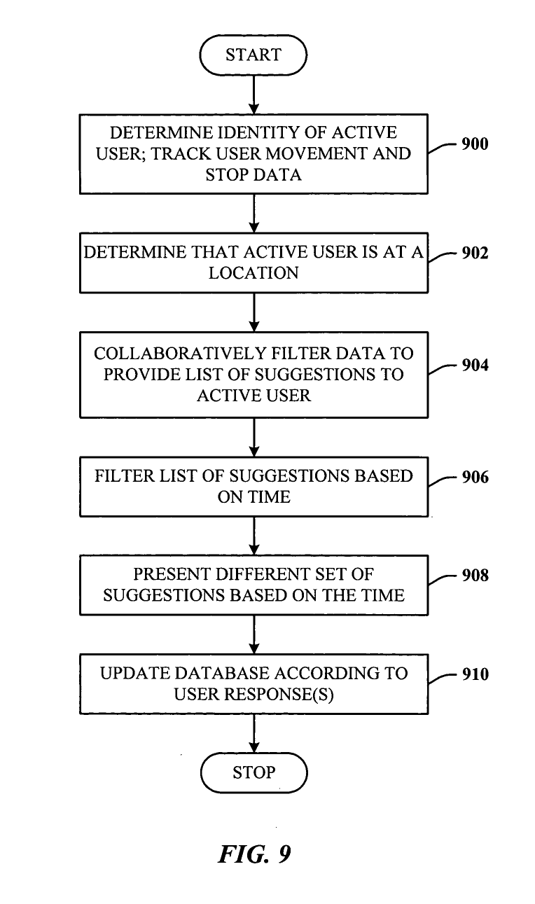

FIG. 9 illustrates a methodology of time filtering as an aspect of collaborative filtering. The reasoning can be can further segmented and focused by considering time of day and day of week, for example. Thus, time-centric collaborative filtering can be performed. The recommendations are weighted or filtered based on time of day and day of week. For example, the system can recommend to a user places that the user has not been to or detected as to have traveled to yet, but that people who are like the active user in terms of where they stop, have gone. This can then be filtered by time. Thus, recommendations will be provided to go to great breakfast places in the early morning, to great dinner spots around dinner time, and to great museums on Saturday afternoons, for example.

At 900, the system monitors and logs user identity, activities and location tracking aspects. At 902, the system determines that the active user is at a location. At 904, the system collaboratively filters data to provide a list of suggestions as to other locations and/or services. At 906, the list is filtered based on time. At 908, based on time, the list of suggestions presented will change. For example, if it is noon, there is no need to suggest that the user eat breakfast at a location that others have frequented in the past, and who have also visited this location. If it is early in the morning, however, then suggestions can range from breakfast to lunch to dinner, for example. This also applies to time in the context of the day of the week, month, holidays, seasons, etc. For example, if it is Thanksgiving, and the weather is cold outside, this can impact the suggestions provided, limiting the suggestion to restaurants that serve related meals and at a place that is currently an inside walk (or a short outside walk) from the active user location. At 910, the database is updated based on user selections and activities.

There are other notable aspects of the disclosed innovation, which include directed advertising. Advertising can be linked to the recommendations. Retail organizations can target users who are likely to enjoy going to a place, based on where they have gone in the past and where people who stop at places like them have gone, with advertisements and special offerings as enticements. This can be accomplished either in realtime as a user approaches a location, during the times that the location would be most relevant—whether the user is in close proximity or not, or in a planning setting—offline, during the morning or evening, when the user is still at work, e.g., and planning an evening during the week.

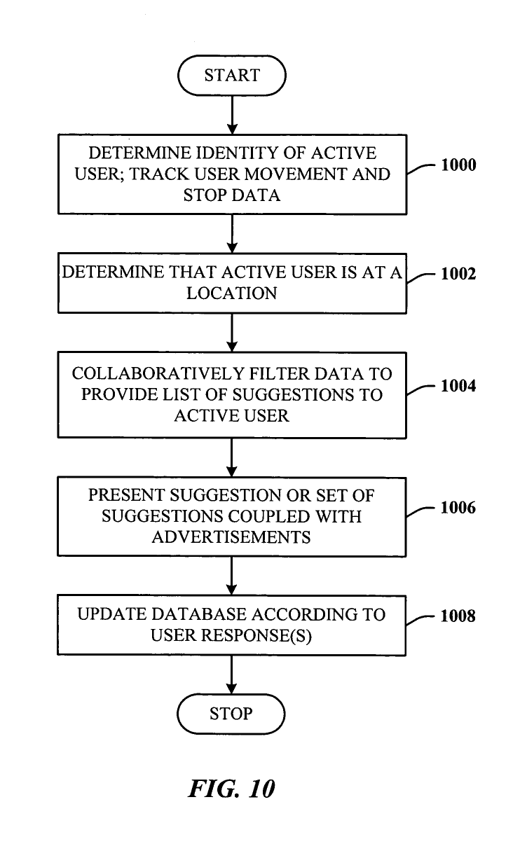

FIG. 10 illustrates a methodology of directing advertising and/or other enticements to the active user as part of the collaborative filtering process. At 1000, the system monitors and logs user identity, activities and location tracking aspects. At 1002, the system determines that the active user is at a location. At 1004, the system collaboratively filters data to provide a list of suggestions as to other locations and/or services. At 1006, the system now includes enticements in the form of advertisements or other information to influence the active user to select one or more of the suggestions. At 1008, the user response(s) are logged and stored in the database.

In another aspect, exact locations are not a focus of the processes, but abstractions (or categories) of the location can be utilized. For example, the types of places people go can be stored such as “used book stores,” or “small quaint coffee shops on the outskirts of cities”, or museums, and even the names of franchised organizations, such as “Starbucks”. Reasoning can be applied to collaborative filtering methods at that level of abstraction. Thus, abstractions can be created by processing specific location data such as Townsend Books→Used Book Store and Powell's Books→Used Bookstore, Club 77→Hip dance club and Flamingos→Hip dance club. To do this, an ontology of locations can be generated. Moreover, base don user responses, the system is suitably robust to react therefrom to move between abstraction suggestions to more specific suggestions, or a combination thereof. To reason at this level, online access to yellow pages and Web-based search can be employed or key on location or locations. Additionally, the use of abstractions helps to generalize, and allows for the use of smaller datasets.

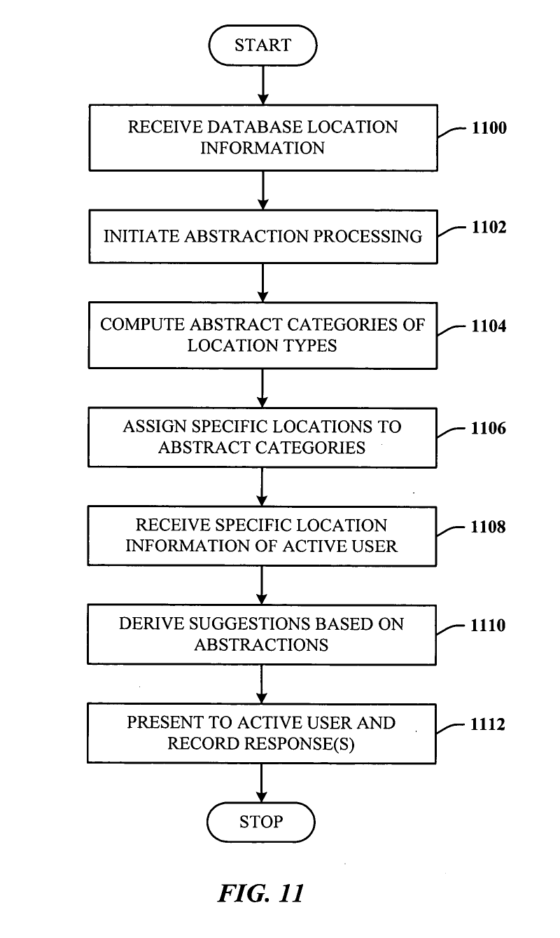

Accordingly, FIG. 11 illustrates a methodology of abstraction processing for locations according to a disclosed aspect. At 1100, location information of a database is received. At 1102, abstraction processing is initiated. At 1104, abstract categories are computed based on the type of location information available. Additional categories can be added as new types of location data are received. At 1106, specific location data is assigned to the categories. At 1108, specific location data associated with the active user is received. At 1110, collaborative filtering provides recommendations that are derived based on the abstract categories. At 1112, the recommendations are presented to the user, and the user response(s) are logged for later processing and storage.

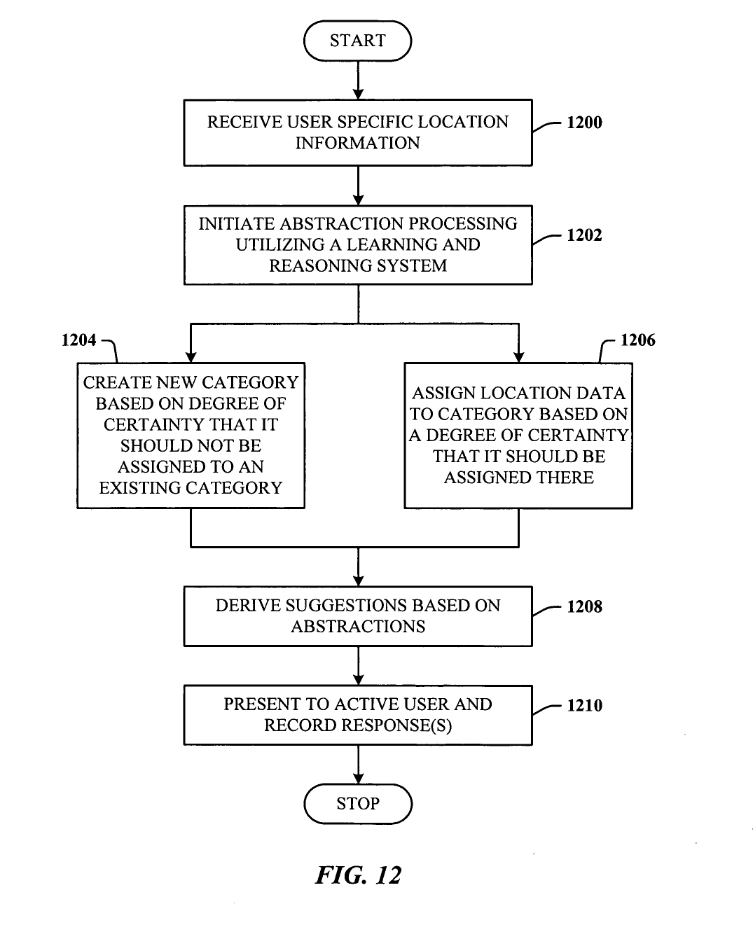

It is to be appreciated that learning and reasoning can be applied to the generation of the abstract categories and for assigning specific user location data to a category or categories. FIG. 12 illustrates a methodology of applying learning and reasoning to an abstraction generation process. At 1200, user specific location data is received. At 1202, abstraction processing is initiated in combination with learning and reasoning processing. At 1204, the location data is assigned to an existing category based on a degree of certainty that it should be assigned there. The learning and reasoning system facilitates automatic determination of which category of a plurality of categories the data is to be assigned, and only assigns it to that single category. In yet another implementation, if, based on the specific location data, the data could be assigned to more than one category, the learning and reasoning system can automatically assign the data to both categories, and thereafter, impose additional processing to derive suggestions from those categories, provided it makes sense to do so from multiple categories. Alternatively, at 1206, a new category is created based on a degree of certainty that the location data should not be assigned to existing categories. When a new category needs to be created, the learning and reasoning system can decide with some degree of certainty what the category should be, and create it. Over time, and based on other information that frequently is received related to that category, the learning and reasoning system can further refine that category, or assigns a new abstraction that fulfills the needs of the collaborative filtering system as a whole. At 1208, as before, the collaborative filtering system derives suggestion based on the category abstractions. At 1210, the suggestions are then presented to the user, and the user responses logged.

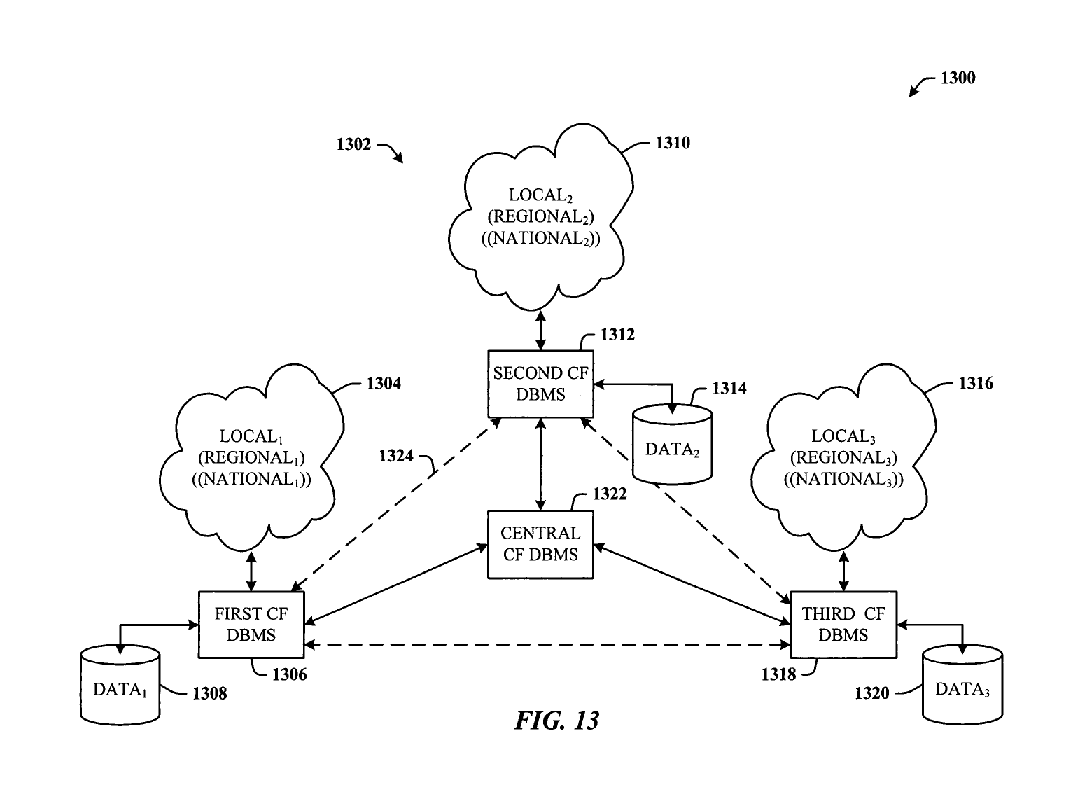

FIG. 13 illustrates a diagram of a system 1300 that coordinates collaborative filtering on a small scale to a large scale. The system 1300 can employ collaborative filtering systems on a small scale, at a local level, centered around blocks of a city, for example. Thus, there is provided a plurality of area systems 1302 each of which can support collaborative filtering (CF) by itself and/or in combination with the other local systems. In a local context, a first local system 1304 (denoted LOCAL₁) can include a first CF database management system (DBMS) 1306 and associated datastore 1308. Similarly, a second local system 1310 (denoted LOCAL₂) can include a second CF DBMS 1312 and associated datastore 1314. A third local system 1316 (denoted LOCAL₃) can include a third CF DBMS 1318 and associated datastore 1320. The local CF systems (e.g., 1304, 1310, and 1316) can interface to each other via a central CF DBMS 1322. Alternatively, the systems (1304, 1310, and 1316) can communicate directly to one another as separate nodes on a common network 1324 instead of via the central CF DBMS 1322.

The system 1300 also finds application on a regional scale. In a regional context, for example, the first regional system 1304 (now denoted REGIONAL₁) can now be one or more states which are supported by the first CF DBMS 1306 and associated datastore 1308. Similarly, the second regional system 1310 (now denoted REGIONAL₂) includes the second CF DBMS 1312 and associated datastore 1314. The third regional system 1316 (now denoted REGIONAL₃) includes the third CF DBMS 1318 and associated datastore 1320. The regional CF systems (e.g., 1304, 1310, and 1316) again, can interface to each other via the central regional CF DBMS 1322. Alternatively, the systems (1304, 1310, and 1316) can communicate directly to one another as separate nodes on the common network 1324 instead of via the central CF DBMS 1322.

The system 1300 also finds application on a national scale. In a national context, for example, the first national system 1304 (now denoted NATIONAL₁) can now be one or more countries which are supported by the first CF DBMS 1306 and associated datastore 1308. Similarly, the second national system 1310 (now denoted NATIONAL₂) includes the second CF DBMS 1312 and associated datastore 1314. The third national system 1316 (now denoted NATIONAL₃) includes the third CF DBMS 1318 and associated datastore 1320. The national CF systems (e.g., 1304, 1310, and 1316) again, can interface to each other via the central national CF DBMS 1322. Alternatively, the systems (1304, 1310, and 1316) can communicate directly to one another as separate nodes on the common network 1324 instead of via the central CF DBMS 1322.

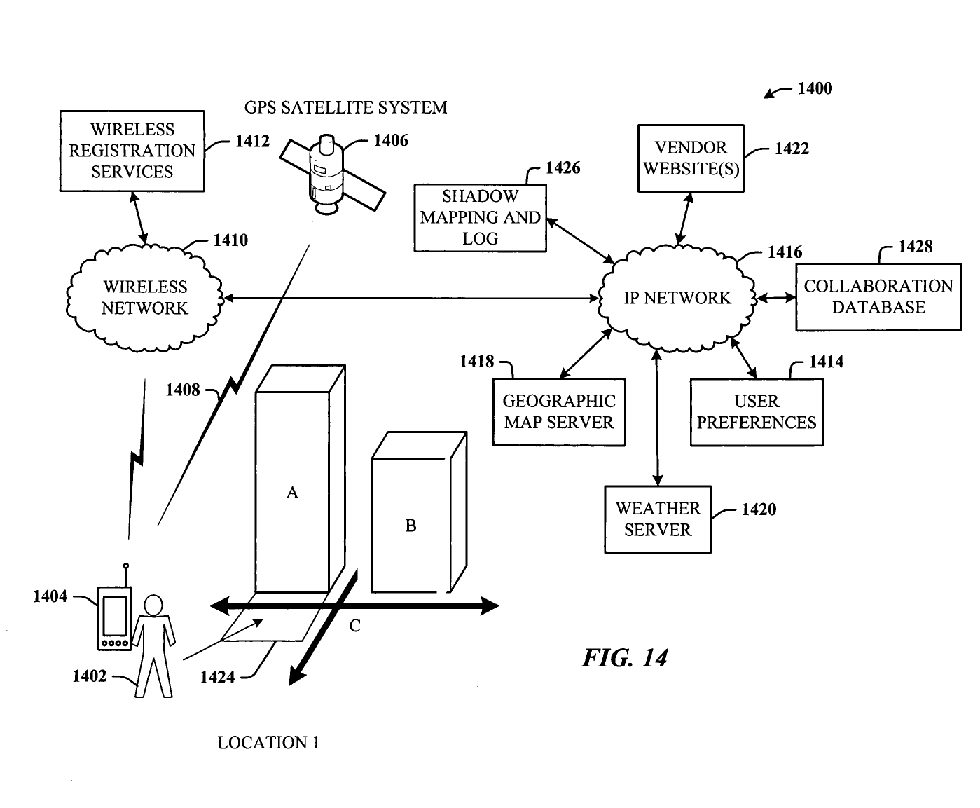

FIG. 14 illustrates a diagram that shows a system 1400 that recommends location and/or services in accordance with the invention. The system 1400 employs GPS, such that a user 1402 operating a device 1404 can be located according to latitude/longitude (“lat/long”) data derived therefrom. A GPS satellite system 1406 continually communicates GPS signals 1408 to the device 1404 so that the device 1404 can compute the lat/long data for the user. If the device 1404 is a WAGPS (wireless-assisted GPS) device, the device 1404 can register with a cellular network 1410 having disposed thereon a wireless registration services system 1412 that registers and uniquely identifies the user 1404 as subscribed to that device 1404. Once the user identity is known, as defined in association with the device 1404, user preferences can be accessed from the registration services system 1412 and/or a user preferences system 1414 disposed on an IP network 1416 (e.g., the Internet) connected to the cellular network 1410. In any case, the user preferences can now be employed as a filter for data being presented to the user via the device 1404 and subscribed services, for the way in which the device 1404 may operate, and for other purposes, as desired, for example.

Once the user location coordinates are known, the coordinates can be used as search terms for search engines of the IP network 1416. Thus, returned search links can be accessed according to some predetermined criteria and/or rules (e.g., use website associated with link A before the website associated with link B) thereby routing to further existing websites such as a geographic map server 1418 that can convert the coordinates into streets and/or addresses, for example. Other websites can also be automatically accessed to obtain additional information such as weather information from a weather website 1420, including temperature, humidity and barometric pressure data, if provided for the location of the user. It is to be appreciated that many different types of rules (or policies) can be implemented to cause automatic searching and linking of website data sources for the desired information. Such rules can be employed as part of the user preferences at the user preference website 1414, as part of the subscriber preferences accessed at the registration services site 1412, and/or even in the user device 1404.

Given that the user location is now approximately known, the nearest street(s) and addresses can be obtained. Additionally, the direction and speed of the user 1402 can also be computed. If the user 1402 is moving in the direction of intersection C, business websites 1422 (grouped together) of businesses (e.g., Company A and Company B) at that intersection or nearby can also be accessed for advertising information. If the user 1402 has a history of shopping at these businesses, specials can be presented to the user 1402 via the device 1404 based on user preferences, availability of preferred products, reminders to the user of products to get when there, etc. The capabilities that can be employed for the user 1402 and the businesses (A and B) when user context and location are known, are enormous.

If the user 1402 should enter a GPS shadow 1424 (a GPS communications blackout zone), or it is determined from user course and speed that the user is about to enter the shadow 1424, other data and operations can be processed and presented to the user, based not only on the user preferences, but also based on how other users interacted when addressing this situation at this location. For example, a shadow mapping and log website 1426 provides a database of shadow mappings that are associated with the structures (of companies A and B) that can be accessed such that when the user enters or is about to enter the GPS shadow 1424, related information can be retrieved from a collaboration database 1428 which suggests alternative routes, and more significantly, routes that other users may have taken to avoid the shadow 1424.

The fact that the user 1402 may pause and dwell at the location may also be interpreted as confusion information such that additional information can be retrieved based on past confusion of the user at this location, and/or past confusion of other users who then resolved the situation at this location in the past. Thus, the system can track the user, monitor user behavior at various locations along a path of travel, present information according to the behavior, the location and combinations thereof, and also present suggested information that was developed from the interaction of other users at this location.

Additionally, in one implementation, inference technology is employed in the device 1404 and/or the network 1416 such that given certain information about the user (e.g., the user's course and speed), a prediction or inference can be made as to what information to present and to further suggest. Thus, it can be appreciated that the number and complexity of parameters to be analyzed can be many in order to determine who to interact with the user.

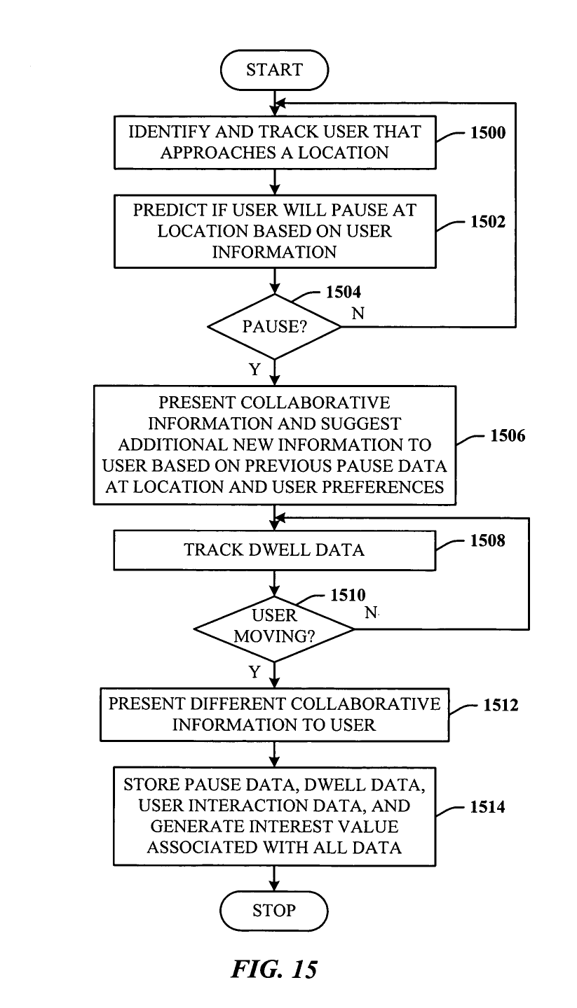

FIG. 15 illustrates a methodology of presenting location and services based on inference information in combination with collaborative filtering and pause/velocity data. At 1500, the user is identified and tracked as he or she approaches a location. At 1502, the system computes a confidence value related to the user pausing or not pausing at the location. At 1504, the system monitors whether the user paused. If not, flow progresses back to 1500 to watch for the next user. If the user does pause, flow is from 1504 to 1506 where information is presented, and suggested new information is also presented to the user based on previous pause data of the user or other users associated with that location, and preferences of the user. At 1508, dwell data of the user is tracked and recorded.

At 1510, the system monitors if the user is moving, indicating termination of dwell mode. If the user is not moving, flow proceeds back to 1508 where the system continues to monitor and record the dwell data (the time that the user stays at or near that location). If the system can detect a change in location coordinates of the user, within a predetermined movement range, the user is defined as moving away from the location, and the system can not only record this, but can be configured to entice the user to stay longer by the presentation of different data, as indicated at 1512. The type of data suggested can be related to environmental conditions, advertising, commuting conditions, food, restaurants, etc., virtually any information deemed to be of interest to the user. This can also include notifications or messages to exit the location for any of a number of reasons, for example. At 1514, while the user interacts or chooses not to interact with the presented data, data is being processed and stored in a large and/or distributed database for later processing and access. This can include, pause data, dwell data, user interaction data, and an interest value that is generated based on what types of information the user chose to perceive, for example.

It can be appreciated that the use of the learning and reasoning system provides additional benefits such as facilitating the determination of when to begin tracking a user relative to a location. For example, the system could be processing information related to millions of users as they pause, dwell, and then move from a location to location. Thus, the associated data processing and management needs can be substantial. In order to provide a more efficient mechanism for handling such demands, the collaborative database system can employ the learning and reasoning technology to make predictions and infer actions of users such that data need not be stored and/or a low sampling rate of such data is required. For example, when a user is traveling faster than a predetermined speed, it may be determined and implemented according to one or more executable rules that there is no need to record information related to this user until the user speed drops below a threshold, indicating that the user may be slowing to take interest in a location. If it determined that the user is taking interest in a particular location, sampling of pause data, dwell data, and user interaction data can be increased. Such a technique can provide a more effective means for dealing with large amounts of data.

In another example, data in the database can be clustered according to rules imposed at predetermined times and/or in accordance with learned conditions. For example, if after the user has been identified, and according to user preferences, it is determined that the user is a pregnant female and thirty years-old, the database can be mined for other similar users who visited that location and interacted in a certain way such that demographics can be employed to facilitate what data will be presented and also what new data will be presented. Accordingly, it is to be appreciated that data clustering can be performed according to any single parameter or combination of parameters.

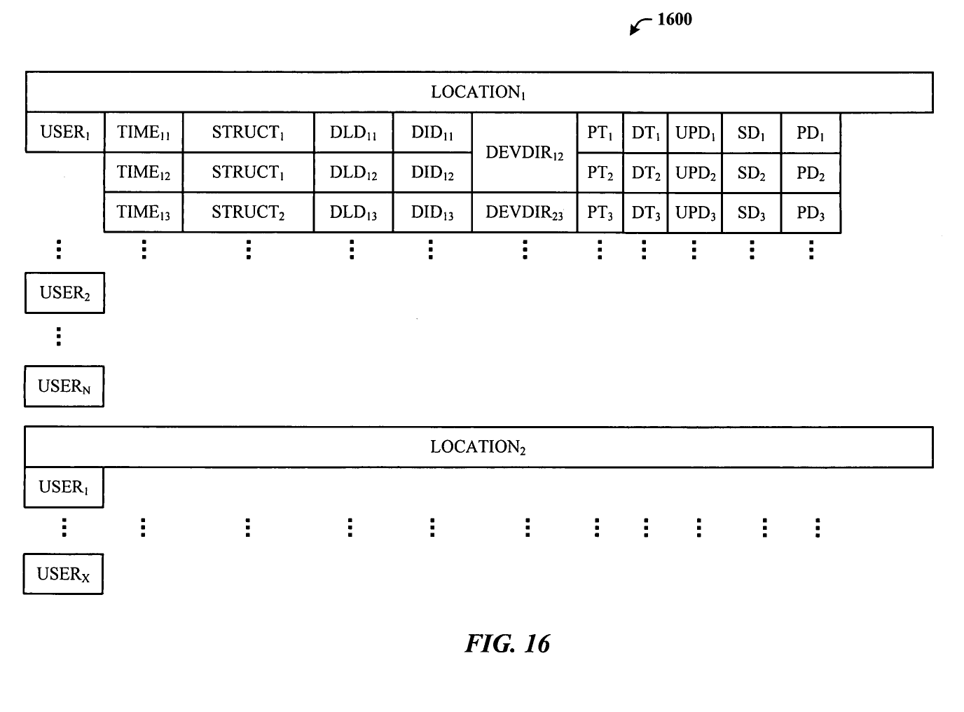

FIG. 16 illustrates an exemplary database 1600 that can be employed to provide location and services recommendation in accordance with the invention. Various levels of categorization can be utilized to learn, track and store data related to a user at a location, including, but not limited to the acquisition and processing of at least device information, device location information, shadow information, user references data, dwell data, pause data, interaction data, previously access data, previously suggested data, user demographics, time, and so on.

In this particular implementation, and not by limitation, the database 1600 can include information related to a first location (denoted LOCATION₁). The first location can be mapped to areas as small as a single address (e.g., a home, office, street, . . . ). Associated with the first location is a first user (denoted USER₁) that has associated therewith other information that can be useful in recommending services and/or locations in accordance with the subject invention.

The first location may be further defined by associated structures (denoted STRUCT₁, STRUCT₂, . . . ), which include any structures (e.g., buildings, trees, bridges, tunnels and mountains). Thus, the location data can further include granularity to structures at or near that location. Associated with the first structure (denoted STRUCT₁) is other data such as the time (denoted TIME₁₁) that device location data (denoted DLD₁₁) was transmitted (or received) from a wireless device of a user that was detected. Other device information that can be associated with the first location such as device identity data (denoted DID₁₁) that uniquely identifies the device from which information is being received, and device direction data (denoted DEVDIR₁₂) that is computed from at least two device location data points (e.g., DLD₁₁ and DLD₁₂) to determine the direction in which the device (and device user) is traveling.

The database 1600 can further include pause time data (denote PT₁), dwell time data (denoted (DT₁), user preferences data (denoted UPD₁), suggested data (denoted SD₁) and presented data (denoted (PD₁). It is to be appreciated that other database fields (not shown) can be employed that are used to further define user activities and demographics (e.g., age, sex, type of vehicle, family members, . . . ), as desired for the particular application of the invention.

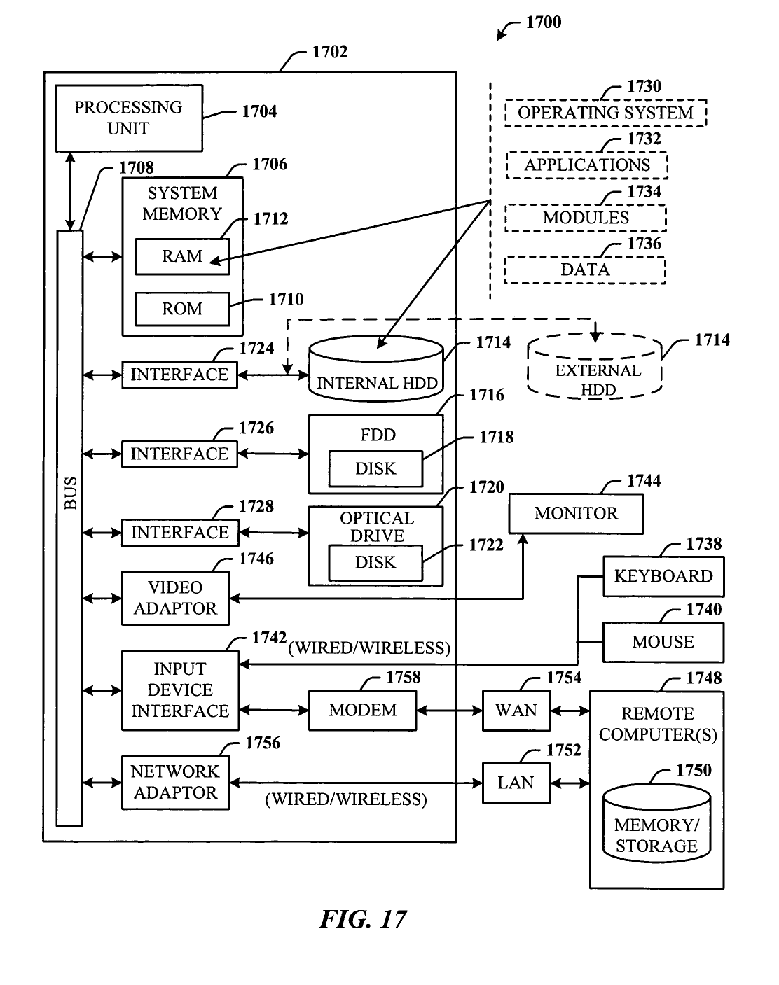

Referring now to FIG. 17, there is illustrated a block diagram of a computer operable to execute collaborative filtering the disclosed architecture. In order to provide additional context for various aspects of the subject invention, FIG. 17 and the following discussion are intended to provide a brief, general description of a suitable computing environment 1700 in which the various aspects of the invention can be implemented. While the invention has been described above in the general context of computer-executable instructions that may run on one or more computers, those skilled in the art will recognize that the invention also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the invention may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and non-volatile media, removable and non-removable media. By way of example, and not limitation, computer-readable media can comprise computer storage media and communication media. Computer storage media includes both volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 17, the exemplary environment 1700 for implementing various aspects of the invention includes a computer 1702, the computer 1702 including a processing unit 1704, a system memory 1706 and a system bus 1708. The system bus 1708 couples system components including, but not limited to, the system memory 1706 to the processing unit 1704. The processing unit 1704 can be any of various commercially available processors. Dual microprocessors and other multi-processor architectures may also be employed as the processing unit 1704.

The system bus 1708 can be any of several types of bus structure that may further interconnect to a memory bus (with or without a memory controller), a peripheral bus, and a local bus using any of a variety of commercially available bus architectures. The system memory 1706 includes read-only memory (ROM) 1710 and random access memory (RAM) 1712. A basic input/output system (BIOS) is stored in a non-volatile memory 1710 such as ROM, EPROM, EEPROM, which BIOS contains the basic routines that help to transfer information between elements within the computer 1702, such as during start-up. The RAM 1712 can also include a high-speed RAM such as static RAM for caching data.

The computer 1702 further includes an internal hard disk drive (HDD) 1714 (e.g., EIDE, SATA), which internal hard disk drive 1714 may also be configured for external use in a suitable chassis (not shown), a magnetic floppy disk drive (FDD) 1716, (e.g., to read from or write to a removable diskette 1718) and an optical disk drive 1720, (e.g., reading a CD-ROM disk 1722 or, to read from or write to other high capacity optical media such as the DVD). The hard disk drive 1714, magnetic disk drive 1716 and optical disk drive 1720 can be connected to the system bus 1708 by a hard disk drive interface 1724, a magnetic disk drive interface 1726 and an optical drive interface 1728, respectively. The interface 1724 for external drive implementations includes at least one or both of Universal Serial Bus (USB) and IEEE 1394 interface technologies. Other external drive connection technologies are within contemplation of the subject invention.

The drives and their associated computer-readable media provide nonvolatile storage of data, data structures, computer-executable instructions, and so forth. For the computer 1702, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the invention.

A number of program modules can be stored in the drives and RAM 1712, including an operating system 1730, one or more application programs 1732, other program modules 1734 and program data 1736. All or portions of the operating system, applications, modules, and/or data can also be cached in the RAM 1712. It is appreciated that the invention can be implemented with various commercially available operating systems or combinations of operating systems.

A user can enter commands and information into the computer 1702 through one or more wired/wireless input devices, e.g., a keyboard 1738 and a pointing device, such as a mouse 1740. Other input devices (not shown) may include a microphone, an IR remote control, a joystick, a game pad, a stylus pen, touch screen, or the like. These and other input devices are often connected to the processing unit 1704 through an input device interface 1742 that is coupled to the system bus 1708, but can be connected by other interfaces, such as a parallel port, an IEEE 1394 serial port, a game port, a USB port, an IR interface, etc.

A monitor 1744 or other type of display device is also connected to the system bus 1708 via an interface, such as a video adapter 1746. In addition to the monitor 1744, a computer typically includes other peripheral output devices (not shown), such as speakers, printers, etc.

The computer 1702 may operate in a networked environment using logical connections via wired and/or wireless communications to one or more remote computers, such as a remote computer(s) 1748. The remote computer(s) 1748 can be a workstation, a server computer, a router, a personal computer, portable computer, microprocessor-based entertainment appliance, a peer device or other common network node, and typically includes many or all of the elements described relative to the computer 1702, although, for purposes of brevity, only a memory/storage device 1750 is illustrated. The logical connections depicted include wired/wireless connectivity to a local area network (LAN) 1752 and/or larger networks, e.g., a wide area network (WAN) 1754. Such LAN and WAN networking environments are commonplace in offices and companies, and facilitate enterprise-wide computer networks, such as intranets, all of which may connect to a global communications network, e.g., the Internet.

When used in a LAN networking environment, the computer 1702 is connected to the local network 1752 through a wired and/or wireless communication network interface or adapter 1756. The adaptor 1756 may facilitate wired or wireless communication to the LAN 1752, which may also include a wireless access point disposed thereon for communicating with the wireless adaptor 1756.

When used in a WAN networking environment, the computer 1702 can include a modem 1758, or is connected to a communications server on the WAN 1754, or has other means for establishing communications over the WAN 1754, such as by way of the Internet. The modem 1758, which can be internal or external and a wired or wireless device, is connected to the system bus 1708 via the serial port interface 1742. In a networked environment, program modules depicted relative to the computer 1702, or portions thereof, can be stored in the remote memory/storage device 1750. It will be appreciated that the network connections shown are exemplary and other means of establishing a communications link between the computers can be used.

The computer 1702 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

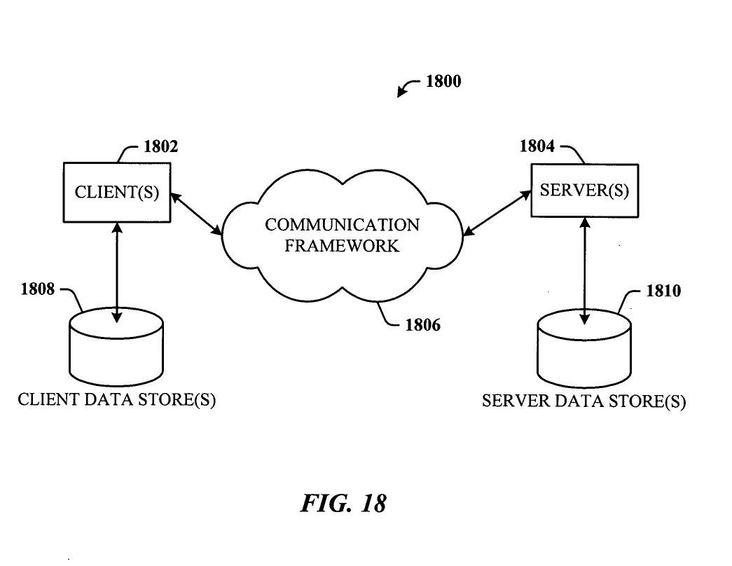

Referring now to FIG. 18, there is illustrated illustrates a schematic block diagram of an exemplary computing environment 1800 in which collaborative filtering can be implemented. The system 1800 includes one or more client(s) 1802. The client(s) 1802 can be hardware and/or software (e.g., threads, processes, computing devices). The client(s) 1802 can house cookie(s) and/or associated contextual information by employing the invention, for example.

The system 1800 also includes one or more server(s) 1804. The server(s) 1804 can also be hardware and/or software (e.g., threads, processes, computing devices). The servers 1804 can house threads to perform transformations by employing the invention, for example. One possible communication between a client 1802 and a server 1804 can be in the form of a data packet adapted to be transmitted between two or more computer processes. The data packet may include a cookie and/or associated contextual information, for example. The system 1800 includes a communication framework 1806 (e.g., a global communication network such as the Internet) that can be employed to facilitate communications between the client(s) 1802 and the server(s) 1804.

Communications can be facilitated via a wired (including optical fiber) and/or wireless technology. The client(s) 1802 are operatively connected to one or more client data store(s) 1808 that can be employed to store information local to the client(s) 1802 (e.g., cookie(s) and/or associated contextual information). Similarly, the server(s) 1804 are operatively connected to one or more server data store(s) 1810 that can be employed to store information local to the servers 1804.

What has been described above includes examples of the disclosed innovation. It is, of course, not possible to describe every conceivable combination of components and/or methodologies, but one of ordinary skill in the art may recognize that many further combinations and permutations are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates recommendation of location and services information, comprising:
a tracking component that tracks a location of a user;
a sensing component that senses interaction data of the user at the location;
a data component that stores data which includes at least tracking data and the interaction data; and
a filtering component that collaboratively filters the data and suggests information to the user.

2. The system of claim 1, wherein the interaction data is related to at least one of speed of the user as the user nears the location and dwell of the user at the location.

3. The system of claim 1, wherein the tracking component utilizes a geographic location technology to determine the location of the user.

4. The system of claim 1, wherein the suggested information is based on at least one of distance and disruption of a current known or inferred route.

5. The system of claim 1, wherein the information is related to a service associated with the location and a nearby location.

6. The system of claim 1, wherein the data component includes a database of information generated from a plurality of users that is continually updated and stores in association with a user at least one of dwell data, pause data, user preferences data, past data presented to the user, suggested data previously presented to the user.

7. The system of claim 1, wherein the data component stores personal data that is related to the user and which the data component anonymizes.

8. The system of claim 1, wherein the data component facilitates an abstraction process that takes location information associated with the location and abstracts to a more general category of location type.

9. The system of claim 1, further comprising a learning and reasoning component that employs a probabilistic and/or statistical-based analysis to prognose or infer an action that a user desires to be automatically performed.

10. A computer-readable medium having stored thereon computer-executable instructions for carrying out the system of claim 1.

11. A server that employs the system of claim 1.

12. A computer-implemented method of recommending information to a user, comprising:
tracking a geographic position of a user relative to a location;
sensing at least one of pause data and velocity data of the user relative to the location;
collaboratively processing stored information of other users that have visited the location, based on the dwell data; and
presenting to the user a suggestion that includes information related to at least one of another location and a service.

13. The method of claim 12, further comprising an act of clustering data of the stored information based on demographics data associated with the user and deriving the suggestion from the clustered data, or from other approaches to collaborative filtering.

14. The method of claim 12, further comprising an act of modifying type and content of the suggestion based on past history of the user frequenting the location.

15. The method of claim 12, further comprising an act of deriving the suggestion based on the location being associated with a communications shadow.

16. The method of claim 12, further comprising an act of deriving the suggestion based on a model that predicts a likelihood that a user would already be familiar with a location or service, including the use of measures of overall popularity or salience of a location or service.

17. The method of claim 12, further comprising an act of deriving the suggestion based upon filtered results of the act of processing and modifying the filtered results based on user preferences.

18. The method of claim 12, further comprising an act of deriving the suggestion based upon a likelihood that the user already knows of the location.

19. The method of claim 12, further comprising an act of deriving the suggestion based upon filtering or an inference made that is based upon month, season, time of day and/or day of week data, and such contextual data as weather, and whether the day is a holiday or a school holiday.

20. A system that facilitates recommending information to a user, comprising:
means for tracking a geographic position of a user relative to a location;
means for sensing interaction data of the user relative to the location;
means for processing stored information associated with other users;
means for deriving a suggestion based upon results of the means for processing; and
means for presenting the suggestion in combination with enticement information that suggests to the user to go elsewhere.
